(19) United States
(12) Patent Application Publication
(10) Pub. No.: US 2023/0127626 A1
(43) Pub. Date: Apr. 27, 2023

(54) METHOD AND APPARATUS FOR PREDICTING SYSTEM THROUGHPUT

(71) Applicant: Dell Products L.P., Round Rock, TX (US)

(72) Inventors: Irfan Gilani, Cedar Park, TX (US); Sreenivas Sathyanarayana Sharma, Round Rock, TX (US)

(73) Assignee: Dell Products L.P., Round Rock, TX (US)

(21) Appl. No.: 17/508,213

(22) Filed: Oct. 22, 2021

(51) Int. Cl. G06N 20/00

(52) U.S. Cl. CPC G06N 20/00

(57) ABSTRACT

A method comprising: obtaining an initial system specification for a system; classifying the initial system specification by using a machine learning model that is configured to yield an estimated system throughput for the system; detecting whether the estimated system throughput is greater than or equal to a required system throughput; and when the estimated system throughput is greater than or equal to the required system throughput, outputting one or more recommended system specifications that are based on the initial system specification.

### BACKGROUND

Computer system retailers are often presented with a set of customer requirements, and tasked with identifying and offering a computing system that meets a predetermined set of customer requirements. Identifying a computing system that satisfies the customer requirements could be a challenging task that is critical to the successful closing of a sale. Furthermore, correctly identifying a computing system that meets the customer requirements could be critical to continued customer satisfaction with the system, after the system is sold.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

According to aspects of the disclosure, a method comprising: obtaining an initial system specification for a system; classifying the initial system specification by using a machine learning model that is configured to yield an estimated system throughput for the system; detecting whether the estimated system throughput is greater than or equal to a required system throughput; and when the estimated system throughput is greater than or equal to the required system throughput, outputting one or more recommended system specifications that are based on the initial system specification.

According to aspects of the disclosure, an apparatus is provided, comprising: a memory; and at least one processor operatively coupled to the memory, the at least one processor being configured to perform the operations of: obtaining an initial system specification for a system; classifying the initial system specification by using a machine learning model that is configured to yield an estimated system throughput for the system; detecting whether the estimated system throughput is greater than or equal to a required system throughput; and when the estimated system throughput is greater than or equal to the required system throughput, outputting one or more recommended system specifications that are based on the initial system specification.

According to aspects of the disclosure, a non-transitory computer-readable medium is provided that stores one or more processor-executable instructions, which, when executed by at least one processor, cause the at least one processor to perform to operations of: a memory; and at least one processor operatively coupled to the memory, the at least one processor being configured to perform the operations of: obtaining an initial system specification for a system; classifying the initial system specification by using a machine learning model that is configured to yield an estimated system throughput for the system; detecting whether the estimated system throughput is greater than or equal to a required system throughput; and when the estimated system throughput is greater than or equal to the required system throughput, outputting one or more recommended system specifications that are based on the initial system specification.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a diagram of an example of a computing system, according to aspects of the disclosure;

FIG. 2 is a diagram of an example of a neural network, according to aspects of the disclosure;

FIG. 3 is a diagram of an example of a part map, according to aspects of the disclosure;

FIG. 4 is a diagram of an example of a precise system specification, according to aspects of the disclosure;

FIG. 5 is a diagram of an example of a generic system specification, according to aspects of the disclosure;

FIG. 6 is a flowchart of an example of a process, according to aspects of the disclosure;

FIG. 7A is a diagram of an example of a recommended system specification, according to aspects of the disclosure;

FIG. 7B is a diagram of an example of a recommended system specification, according to aspects of the disclosure;

FIG. 7C is a diagram of an example of a recommended system specification, according to aspects of the disclosure;

FIG. 8 is a flowchart of an example of a process, according to aspects of the disclosure;

FIG. 9 is diagram of a performance data set, according to aspects of the disclosure; and

### DETAILED DESCRIPTION

A computer retailer may focus on customer outcomes rather than hardware configurations. As far as customers are concerned, they have workloads (aka applications) that require a certain amount of capacity and throughput and they are less concerned about the exact hardware configuration that delivers that capacity and throughput. In this regard, a computer retailer can provide “as-a-service” offerings which deliver exactly that. For example, with storage-as-a-service, a computer retailer may offer pre-defined plans that offer a certain capacity and throughput for a storage space, at a certain subscription price. As another example, with gaming-pc-as-a-service offerings, a computer retailer may offer gamers a managed gaming pc with a guaranteed frames-per-second performance score to run their favorite games.

In general, once a customer has chosen an “as-a-service” plan, the burden is on the computer retailer to determine the exact hardware configuration that needs to be shipped and deployed to meet the customer's expectation of capacity and throughput. This presents the problem of how a computer retailer determines the exact configuration that must be ordered, shipped, and deployed to meet the customer's expectation of capacity and throughput. For example, while the capacity of a system (e.g., a storage device or storage system, etc.) is easy to discern, throughput for a particular hardware configuration is harder to predict—it depends on a variety of factors such as hardware type, technology, workloads, deployment topology, network, etc.

Currently, as-a-service offerings are crafted manually by subject matter experts. Such subject matter experts may help create as-a-service offerings and the corresponding hardware configurations to meet the throughput service level agreements (SLA) for the as-a-service offers. These configurations are tested in experts' labs, with simulations of real-world scenarios, to ensure that they do indeed meet the SLAs. This process, however, takes a lot of time and energy, significantly slowing down the type and number of as-a-service offers that can be produced by an organization.

The present disclosure is directed to a method and system that can be used to automate certain aspects of the generation of an as-a-service offering, thus increasing the efficiency at which as-a-service offerings can be produced by an organization. The method and system predict a system throughput (e.g. IOPS) based on an attribute set that describes the hardware configuration of a product (i.e., the hardware configuration of a system). Unlike existing methods for the generation of as-a-service offers, the method and system do not require configurations to be manually created and tested for throughput (e.g. IOPS). Rather, the method and system utilize an Artificial Neural Network (ANN), which is trained based on telemetry data that is reported by existing systems that are deployed with different customers. Once trained, this ANN is used to predict the throughput (e.g., IOPS) that would result from a particular hardware configuration of the system.

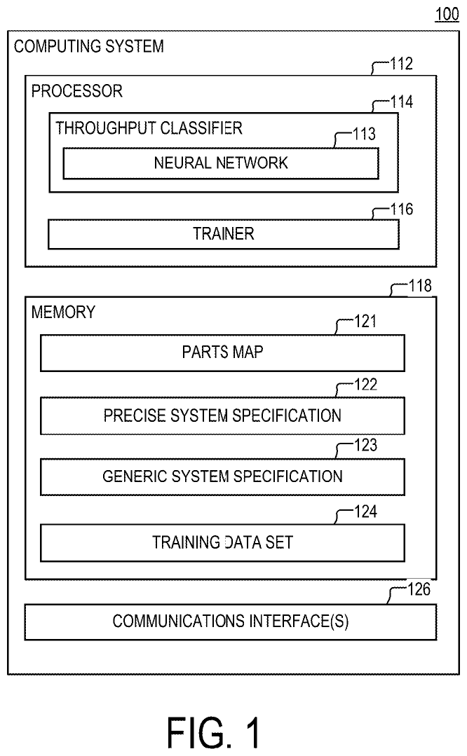

FIG. 1 is a diagram of an example of a computing system 100, according to aspects of the disclosure. The computing system 100 may include a processor 112, a memory 118, and a communications interface 126. The processor 112 may include any of one or more general-purpose processors (e.g., x86 processors, RISC processors, ARM-based processors, etc.), one or more Field Programmable Gate Arrays (FPGAs), one or more application-specific circuits (ASICs), and/or any other suitable type of processing circuitry. The memory 118 may include any suitable type of volatile and/or non-volatile memory. In some implementations, the memory 118 may include one or more of a random-access memory (RAM), a dynamic random memory (DRAM), a flash memory, a hard drive (HD), a solid-state drive (SSD), a network accessible storage (NAS), and or any other suitable type of memory device. The communications interface(s) 126 may include any suitable type of communications interface, such as one or more Ethernet adapters, one or more Wi-Fi adapters (e.g., 802.1414 adapters), and one or more Long-Term Evolution (LTE) adapters, for example.

The processor 112 may be configured to execute a throughput classifier 114 and a trainer 116. The throughput classifier 114 may be configured to execute a neural network 113 for predicting the throughput that would result from a particular configuration of a system. In some implementations, the neural network 113 may receive as input a representation of the hardware configuration of a system and output an indication of the throughput, which the system is expected to have. Additionally or alternatively, in some implementations, the neural network 113 may output an indication of a throughput range in which the actual throughput of the system is expected to fall. The trainer 116 may be configured to implement a supervised learning algorithm for training the neural network 113. Furthermore, the trainer 116 may be configured to generate a training data set 124 and use the training data set 124 for the purpose of training the neural network 113 (i.e., to train the throughput classifier 114, etc.). In some implementations, the trainer 116 may generate the training data set 124 in accordance with a process 800, which is discussed further below with respect to FIG. 8.

According to the present example, the neural network 113 includes a fully connected neural network. However, alternative implementations are possible in which the neural network 113 includes another type of neural network, such as a convolutional neural network, etc. In other words, it will be understood that the present disclosure is not limited to any specific type of neural network being used. Although in the example of FIG. 1, the throughput classifier 114 implements a neural network, it will be understood that alternative implementations are possible in which another type of machine learning model is used to classify a system specification into throughput categories, such as a decision tree, a support vector machine, a logistic regression predictor, etc.

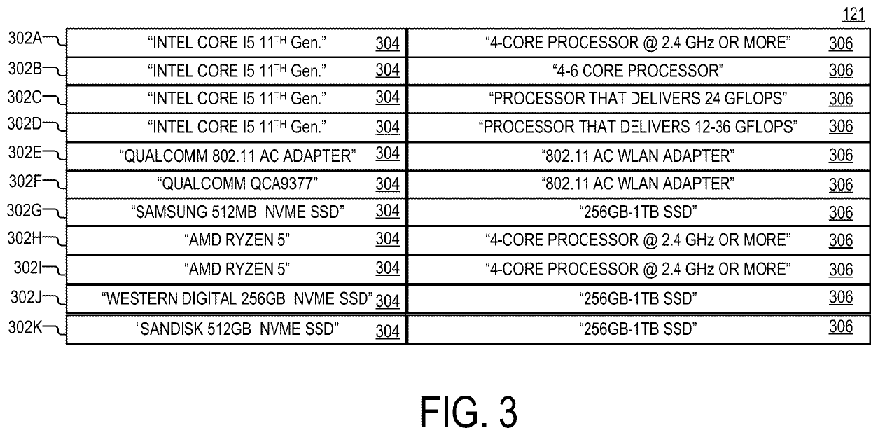

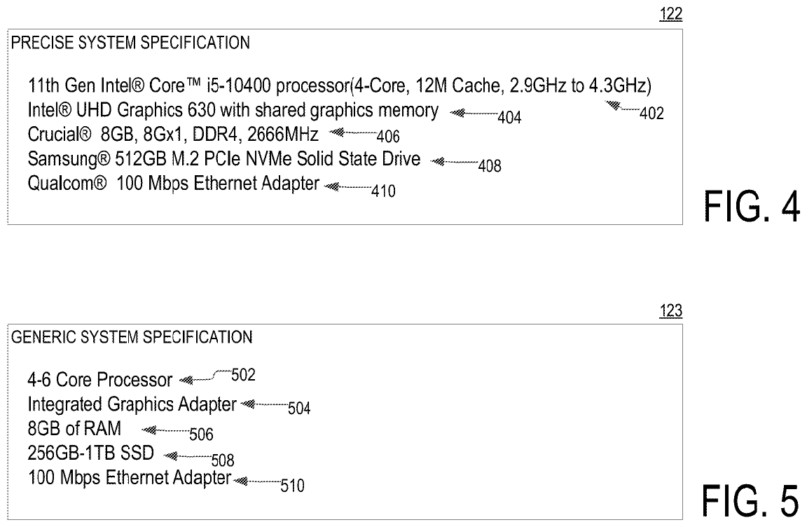

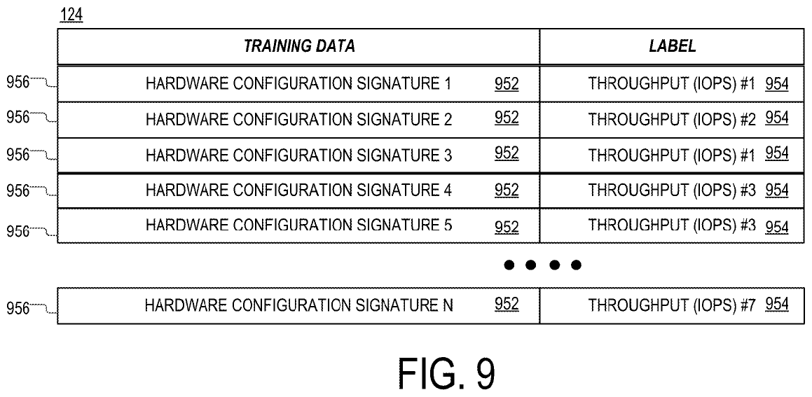

The memory 118 may be configured to store a parts map 121, a precise system specification 122, a generic system specification 123, and the training data set 124. The parts map 121 may include one or more data structures that map each of a plurality of part characteristics to a corresponding performance characteristic. An example of the parts map 121 is discussed further below with respect to FIG. 3. The precise system specification 122 may be a full or partial description of the hardware configuration of a system, which describes the hardware configuration in terms of one or more part identifiers. An example of the precise system specification 122 is discussed further below with respect to FIG. 4. The generic system specification 123 may be a more generalized representation of the hardware configuration of a system, which describes the hardware configuration in terms of one or more performance characteristics. An example of the generic system specification 123 is discussed further below with respect to FIG. 5. The training data set 124 may include a data set that is used to train the neural network 113. An example of the training data set 124 is provided further below with respect to FIG. 9.

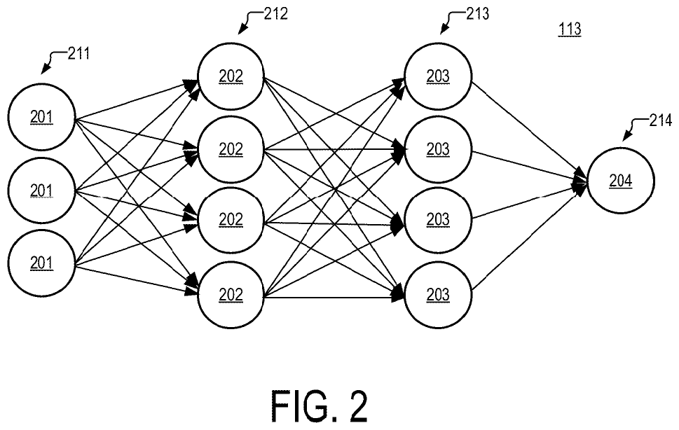

FIG. 2 is a diagram illustrating the neural network 113, according to one implementation. As illustrated, the neural network 113 may include an input layer 211, a hidden layer 212, a hidden layer 213, and an output layer 214. The input layer 211, according to the example of FIG. 2, includes three input neurons 201. However, it will be understood that alternative implementations are possible in which the input layer 211 includes any number of input neurons 201. The hidden layer 212, according to the example of FIG. 2, includes four hidden neurons 202. However, it will be understood that alternative implementations are possible in which the hidden layer 212 includes any number of hidden neurons 202. The hidden layer 213, according to the example of FIG. 2, includes four hidden neurons 203. However, it will be understood that alternative implementations are possible in which the hidden layer 213 includes any number of hidden neurons 203. The output layer 214, according to the example of FIG. 2, includes one output neuron 204. However, it will be understood that alternative implementations are possible in which the output layer 214 includes any number of output neurons 204.

FIG. 3 is a diagram of an example of the parts map 121, according to aspects of the disclosure. As illustrated, the parts map 121 may include a plurality of entries 302. Each entry 302 may map a respective part identifier 304 to a corresponding performance identifier 306.

As used herein, the term “part identifier” refers to an identifier that identifies one or more parts. An example of a part identifier is a specific part number (e.g. “QCA9377”), which uniquely identifies only one part. Another example of a part identifier is a manufacturer name combined with a part type (e.g., “Qualcomm 802.11AC adapter”)—in this example, the part identifier may refer to a set of parts that are made by the same manufacturer.

As used herein, the term “performance identifier” refers to an identifier that identifies two or more parts. One distinction between a given part identifier and a corresponding performance identifier that is mapped to the given part identifier (by parts map 121) is that the performance identifier would identify a greater number of parts that have the same or similar performance as the part(s) identified by the given part identifier.

The part identifier 304 in each of entries 302A-D is “Intel Core I5 11^{th} Gen processor”, and performance identifiers 306 for entries 302A-D include “4-core processor that has clock frequency of 2.4 GHz or more”, “4-6 core processors”, “a processor that delivers 24 GFLOP”, and “a processor that delivers 12-36 GFLOPS”. Together, entries 302A-D illustrate that the performance identifiers that correspond to a given part identifier may identify: (i) a particular structural characteristic that must be possessed by a part (e.g., 4 cores), (ii) a range of structural characteristics, at least one of which must be possessed by the part (e.g., 4-6 cores), (iii) the value of a performance metric value (e.g., 24 GFLOPS) which the part must be able to meet, or (iv) a range of performance metric values (e.g., 12-36 GFLOPS) where the performance of the part must fall. Furthermore, in another respect, entries 302A-D further illustrate that in some implementations, a “part identifier” may be specific to a particular part manufacturer (and/or designer), such as Intel™, whereas any “performance identifier” that is mapped (or corresponds) to the part identifier may be agnostic with respect to part manufacturer/designer.

The part identifiers 304 in entries 302E-F are “Qualcomm 802.11ac adapter” and “Qualcomm QCA93377”. Those part identifiers 304 are mapped to a performance identifier 306, which is “802.11ac WLAN adapter”. Together, entries 302E-F illustrate that the part identifier for a particular part may include a specific part number or it may encompass a plurality of parts that are sold by the same manufacturer.

The performance identifier 306 in each of entries 302A, 302H, and 302I is “4-core processor that has clock frequency of 2.4 GHz or more”. The part identifiers 304 in each of entries 302A, 302H, and 302I include “Intel Core I5 11^{th} Gen processor,” “AMD Ryzen 5,” and “AMD Ryzen 5,” respectively. Together, entries 302A, 302H, and 302I illustrate that the same performance identifier can be mapped to different part identifiers by the parts map 121.

The performance identifier 306 in each of entries 302G, 302J, and 302K is “4-core processor that has clock frequency of 2.4 GHz or more”. The part identifiers 304 in each of entries 302G, 302J, and 302K include “Samsung 512 MB NVME SSD,” “Western Digital 256 GB NVME SSD,” and “Sandisk 512 GB NVME SSD,” respectively. Together, entries 302A, 302H, and 302I illustrate that the same performance identifier can be mapped to different part identifiers by the parts map 121.

The parts map 121 may be used to map part identifiers to corresponding performance identifiers. As is discussed further below, the performance identifiers may be included in the generic system specification 123, and they may be used by the neural network 113 to analyze the expected throughput of a proposed hardware specification. Furthermore, the parts map 121 may be used to map performance identifiers to part identifiers. As is discussed further below, the parts map 121 may be used to identify different parts that have the same or similar performance, and which can be used to propose, to a customer, different hardware configurations for a system that are expected to have the same throughput performance at different price points. In some respects, the performance identifiers may be used to identify alternatives to a precise system specification that has been analyzed and determined to have sufficient throughput.

FIG. 4 is a diagram of the precise system specification 122, according to one implementation. As illustrated, the precise system specification 122 may include part identifiers 402-410. In the example of FIG. 4, the system specified by the precise system specification 122 is a desktop computer. However, alternative implementations are possible in which the system specified by the precise system specification 122 includes another type of system, such as a laptop computer, a smartphone, a tablet, an industrial computer, a WLAN device, a managed wired switch, a storage array, an analog device such as a signal amplifier, and/or any other suitable type of electronic system. In this regard, it will be understood that the term “system” as used in the context of “specification for a system” may refer to a list of hardware parts that, at least in part, specifies the hardware configuration of any type of electronic device or system. (E.g., digital device/system and/or analog device/system, etc.) In the example of FIG. 4, part identifier 402 identifies a specific type of processor, part identifier 404 identifies a specific type of graphics adapter, part identifier 406 identifies a specific type of RAM memory, part identifier 408 identifies a specific type of storage device, and part identifier 410 identifies a specific type of Ethernet adapter.

FIG. 5 is a diagram of the generic system specification 123, according to one implementation. The generic system specification 123 is generated based on the precise system specification 122, and it includes performance identifiers 502-510. The generic system specification 123 is generated by replacing each of the part identifiers 402-410 with a corresponding performance identifier. The generic system specification 123 may be generated by the processor 112. The generic system specification 123 may be generated by executing the following steps: (i) instantiate the generic system specification 123, (ii) retrieve a part identifier from the precise system specification 122, (iii) perform a search of the parts map 121 to identify one or more performance identifiers that are mapped (by the parts map 121) to the retrieved part identifier, and (iv) insert all (or fewer than all) of the identified performance identifiers into the generic system specification 123. In the example of FIG. 5, steps ii-iv are repeated once for each and every of the part identifiers that constitute the precise system specification 122. However, alternative implementations are possible in which steps ii-iv are repeated for fewer than all of the part identifiers that are part of the precise system specification 122. In such implementations, the generic system specification 123 may include some of the part identifiers that are part of the precise system specification 122, as well as one or more performance identifiers that are used to replace other ones of the part identifiers in the precise system specification 122.

Performance identifier 502 may identify a set of processors that have the same or similar performance to the processor(s) identified by part identifier 402. Performance identifier 502 may identify a larger number of processors than part identifier 402. Performance identifier 504 may identify a set of graphic adapters that have the same or similar performance to the graphic adapter(s) identified by part identifier 504. Performance identifier 504 may identify a larger number of graphics adapters than the part identifier 402. Performance identifier 506 may identify a set of RAM memory modules that have the same or similar performance to the RAM device(s) identified by part identifier 406. Performance identifier 506 may identify a larger number of RAM devices than the part identifier 406. Throughout the disclosure, the terms “capacity” and “performance” may be used interchangeably, when permitted by context. Performance identifier 508 may identify a set of SSD devices that have the same or similar performance to the SSD device(s) identified by part identifier 408. Performance identifier 508 may identify a larger number of SSD devices than part identifier 408. Performance identifier 510 may identify a set of Ethernet adapters that have the same or similar performance to the Ethernet adapter(s) identified by part identifier 410. Performance identifier 510 may identify a larger number of Ethernet adapters than part identifier 410.

Performance identifier 502 may be identified by using the parts map 121 to map part identifier 402 to performance identifier 502. Performance identifier 504 may be identified by using the parts map 121 to map part identifier 404 to performance identifier 504. Performance identifier 506 may be identified by using the parts map 121 to map part identifier 406 to performance identifier 506. Performance identifier 508 may be identified by using the parts map 121 to map part identifier 408 to performance identifier 508. Performance identifier 510 may be identified by using the parts map 121 to map part identifier 410 to performance identifier 510.

FIGS. 4-5 are provided as an example only. The term “precise” as used in the phrase “precise system specification” is not intended to imply any specific level of precision (in fact some of the part identifiers 402-410 may be applicable to multiple parts). Rather, the term “precise” as used in the phrase “precise system specification” is intended to convey that the precise system specification would be more specific than a generic system specification that is generated based on the precise system specification.

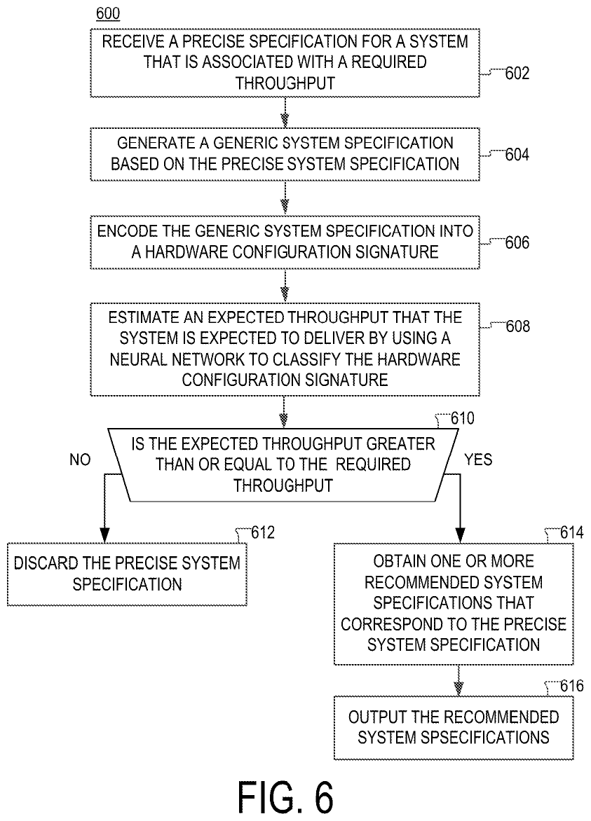

FIG. 6 is a flowchart of an example of a process 600, according to aspects of the disclosure. According to the present example, the process 600 is performed by the computing system 100 and/or the processor 112. However, the present disclosure is not limited to any specific entity or group of entities executing the process 600.

At step 602, a precise system specification is received. The precise system specification may be the same or similar to the precise system specification 122. The precise system specification may identify one or more parts that form the hardware configuration of a system. The system may be one that is considered for fulfilling an as-a-service offering, and it may be one that is required to have a particular throughput (hereinafter “required throughput”). The required throughput may be mandated by a service level agreement for the as-a-service offering. The purpose of the process 600 is to determine whether the precise hardware configuration/system would be capable of meeting the required throughput—i.e., determining whether the precise hardware configuration/system can be used at all to fulfill the as-a-service offering.

At step 604, a generic system specification is generated based on the precise system specification. The generic system specification may be the same or similar to the generic system specification 123. The generic system specification may (at least partially) express the precise system specification in terms of performance identifiers, rather than part identifiers.

At step 606, the generic system specification is encoded into a hardware configuration signature. The hardware configuration signature may include a plurality of bits. Each bit in the hardware configuration signature may correspond to a specific part (e.g., Qualcomm™ QCA9377) or a specific group of parts (e.g., any part that has the same (or comparable) performance as Qualcomm™ QCA9377). When the bit is set to ‘1’, this may be an indication that the part or part group is included in the generic system specification. When the bit is set to ‘0’ this is an indication that the part or part group is absent from the generic system specification.

At step 608, the generic system specification is classified with the neural network 113 (or any other suitable type of machine learning model) to determine an estimated system throughput for the system (i.e., the system that is specified by the precise system specification (received at step 602) or the generic system specification (generated at step 604)). As a result of the classification, an estimated throughput is generated for the system. The estimated throughput may be a singular throughput value or a range of throughput values.

At step 610, the estimated throughput (determined at step 608) is compared to the required throughput. If the estimated throughput is less than the required throughput, the process 600 proceeds to step 612. Otherwise, if the estimated throughput is greater than or equal to the required system throughput, the process 600 proceeds to step 614.

At step 612, the precise system specification (received at step 602) is discarded. Discarding the precise system specification may include deleting (or garbage-collecting) any of the precise system specification (received at step 602), the generic system specification (generated at step 604), or the hardware configuration signature (generated at step 606). Additionally or alternatively, in some implementations, discarding the precise system specification may include outputting a notification that the precise system specification does not satisfy the throughput that is required for the as-a-service offering.

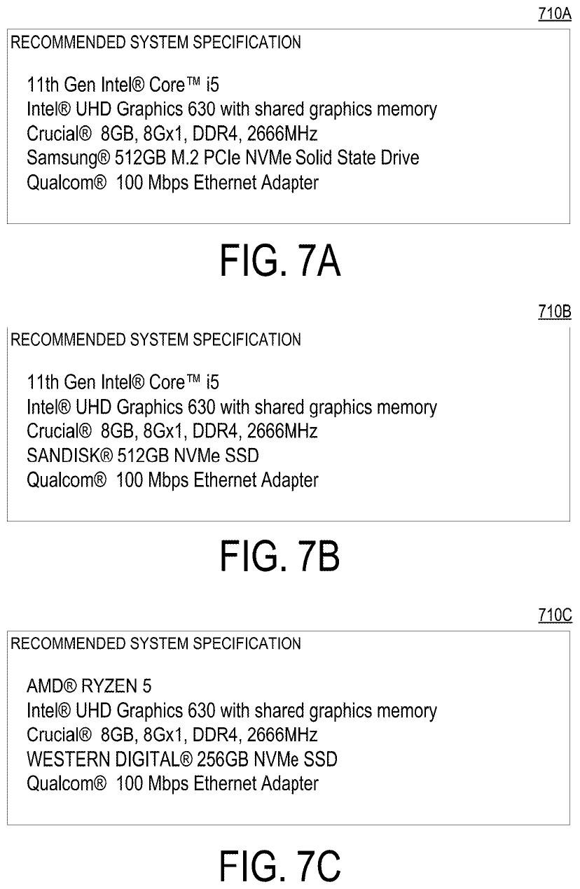

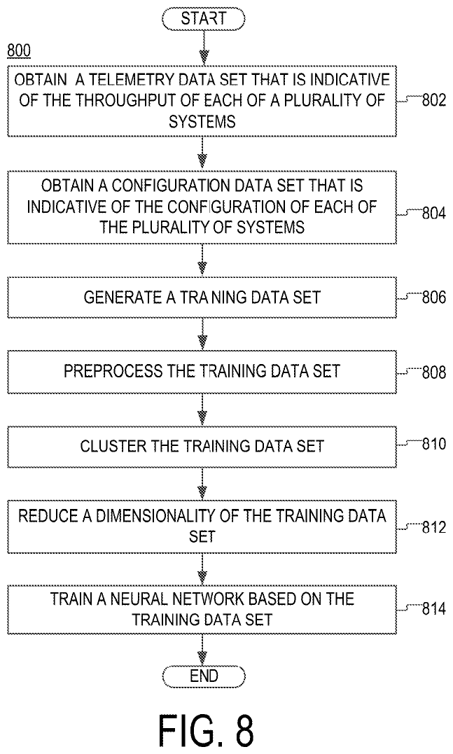

At step 614, one or more recommended system specifications are generated. Generating the one or more recommended system specifications may include retrieving the precise system specification (received at step 602) from memory and using the precise service specification as a recommended service specification. Additionally or alternatively, in some implementations, generating the one or more recommended system specifications may include generating new precise system specifications by reverse-mapping performance identifiers that are part of the generic system specification (generated at step 604) to corresponding part identifiers. Any of the recommended system specifications may be the same or similar to one of the recommended system specifications 710A-C, which are discussed further below with respect to FIGS. 7A-C.

At step 616, the one or more recommended system specifications are output. Outputting any of the recommended system specifications may include displaying an indication of the recommended system specification on a display device. Additionally or alternatively, outputting any of the recommended system specifications may include transmitting the indication, over a communications network, to a client terminal, an operator terminal, and/or any other computing device. In some implementations, a respective cost (e.g., price) of each of the recommended system specifications may be also output to give the user an idea of the cost associated with each of the options represented by the recommended system specifications.

The precise service specification (received at step 602) may be generated manually by a user (e.g., a subject matter expert) and provided as input to the computing system 100. Alternatively, the precise service specification may be generated by a software utility that is configured to automate the process of generating precise system specifications.

Classifying the generic system specification (at step 602) includes executing the neural network 113 by using the generic system specification (and/or the hardware configuration signature generated at step 606) as input. Executing the neural network 113 (or another machine learning model) may yield an estimated system throughput for the system. The “estimated system throughput” may include any suitable number, string, or alphanumerical string that identifies a throughput level that can be reliably achieved by the system (that is specified by the precise system specification (received at step 602) or the generic system specification (received at step 604)). In the present example, the estimated system throughout includes an IOPS value. The IOPS value may pertain to the frame rate of the graphics output of system, the rate at which the system executes read or write requests to permanent storage, the rate at which the system executes read or write requests to RAM, and/or any other suitable aspect of the operation of the system. Although in the present example the estimated system throughput that is determined at step 608 includes IOPS, it will be understood that the present disclosure is not limited thereto.

Although in the example of FIG. 6, a precise system specification is received at step 602, alternative implementations are possible in which a generic system specification is received instead. In such implementations, step 604 may be omitted. Although in the example of FIG. 6, a generic system specification is classified, alternative implementations are possible in which the precise system specification is classified instead. The system specification that is classified by the neural network 113, whether be it a precise system specification or a generic system specification, may be referred to as an initial system specification. The phrase “classifying a precise system specification” may refer to one of “classifying the precise system specification”, “classifying a generic system specification that is generated based on the precise system specification”, “classifying a hardware configuration signature that is generated based on the precise system specification”, or “classifying a hardware configuration signature that is generated based on the generic system specification.” Although in the example of FIG. 6, the classification at step 608 is performed by a neural network, alternative implementations are possible in which another machine learning model is used.

FIG. 7A-C illustrate examples of recommended system specifications 710A-C, respectively. Recommended service specification 710A (shown in FIG. 7A) is the same as the precise system specification 122, which may be received as input at step 602 of the process 600. FIG. 7A is provided to illustrate that a recommended service specification that is output at step 616 of the process 600 may be the same as the precise system specification that is input at step 602. FIG. 7B shows an example of a recommended system specification 710B, which is generated based on the generic system specification (obtained at step 604). FIG. 7C shows an example of a recommended system specification 710C that is generated based on the generic system specification (obtained at step 604). The example of FIGS. 7A-C assumes that the generic system specification obtained at step 604 is the same as the generic system specification 123 (shown in FIG. 4).

Each of recommended system specifications 710B-C may be generated based on the generic system specification that is obtained at step 604. Each of recommended system specifications 710B-C may be generated by the processor 112. Each of recommended system specifications 710B-C may be generated by executing the following steps: (i) instantiate a recommended system specification, (ii) retrieve a performance identifier from the generic system specification, (iii) perform a search of the parts map 121 to identify a part identifier that is mapped (by the parts map 121) to the retrieved performance identifier, and (iv) include the part identifier into the recommended system specification. In the present, steps ii-iv are repeated once for each and every of the performance identifiers in the generic system specification. However, alternative implementations are possible in which steps ii-iv are repeated for fewer than all of the performance identifiers.

In the example of FIGS. 7B-C, the recommended system specification 710B is generated by replacing performance identifier “4-6 Core Processor” with part identifier “11th Gen Intel Core™ i5” and the recommended system specification 710C is generated by replacing performance identifier “4-6 Core Processor” with part identifier “AMD Ryzen 5”. Furthermore, in the example of FIGS. 7B-C, the recommended system specification 710B is generated by replacing performance identifier “256 GB-1 TB SSD drive” with part identifier “Sandisk 512 GB NVMe SSD” and the recommended system specification 710C is generated by replacing performance identifier “256 GB-1 TB SSD drive” with part identifier “Western Digital GB NVMe SSD”. FIGS. 7B-C illustrate that different recommended system specifications may be generated by replacing the same performance identifier in a generic system specification with different part identifiers.

FIG. 8 is a flowchart of an example of a process 800 for generating the training data set 124 and training the neural network 113. According to the example of FIG. 8, the process 800 is performed by the trainer 116. However, the present disclosure is not limited to the process 800 being executed by any specific entity.

At step 802, a telemetry data set is obtained. The telemetry data set may include a plurality of data items. Each of the data items may be reported by a different system (e.g., computing system), and it may identify the throughput of the system. The telemetry data items may be retrieved from a centralized repository or received directly from the reporting systems. In most practical implementations, the telemetry data set may include data that is collected by an organization (providing the as-a-service offering discussed with respect to FIG. 6) over the course of its normal operations—i.e., over the course of ordinary support assist or IoT gateway aggregation. Each of the received data items may be associated with a system tag that identifies the system that generated the data item. In some implementations, the system tag for each data item may identify uniquely the system that generated the data item.

At step 804, the configuration data set is obtained. The configuration data set may include a plurality of configuration data subsets. Each subset may identify the configuration of the system that generated a different respective one of the telemetry data items. Each subset may be retrieved, from a database, based on a telemetry data item's corresponding system tag. Each subset may identify hardware that is standard, as well as hardware that is selected as a customer option. In some implementations, the standard hardware and the optional hardware may be retrieved from different databases.

At step 806, a training data set is generated by combining the data sets obtained at steps 802 and 804.

At step 808, the training data set is pre-processed. Pre-processing the training data set may include splitting the data set into training and test data, applying feature scaling using standardization, and/or performing any other suitable training technique.

At step 810, the training data set is clustered. According to the present example, the training data set is clustered by using K-means clustering. However, the present disclosure is not limited to using any specific training technique.

At step 812, the dimensionality of the training data set is reduced. According to the present example, the dimensionality of the training data set is reduced by using principal component analysis. However, the present disclosure is not limited to any specific method for reducing the dimensionality of the training data set. The resulting data set, after step 812 is performed, may be the same or similar to the training data set 124.

At step 814, the neural network 113 is trained based on the training data set.

FIG. 9 is a diagram of an example of the training data set 124. As illustrated in FIG. 9, the training data set may include a plurality of portions 956. Each portion 956 may include a hardware configuration signature 952 and a corresponding throughput identifier 954. The respective throughput identifier 954 of any given portion 956 may be generated based on telemetry data that is reported by a system whose hardware configuration is identified by the given potion's 956 hardware configuration signature 952. As can be readily appreciated, the training data set 124 can be used as a basis for executing a supervised learning process with the neural network 113.

FIGS. 1-9 provide examples of processes and systems that can be used to facilitate the generation of as-service offerings by an organization. The processes and systems can be used to evaluate the throughput of a system that is being offered under a guarantee that the system is capable of achieving specific throughput. The processes and system receive as input a hardware configuration for the system, and output an indication of whether the hardware configuration is capable of delivering the guaranteed throughput that is being.

In one aspect, the processes and systems take advantage of telemetry data to train a neural network (or another machine learning model) to classify hardware configurations according to expected throughput. Such telemetry data may be routinely reported by hardware as a matter of course or during interactions with customer support personnel.

In another aspect, the processes and systems take a generic system specification to determine whether a particular system is capable of achieving desired throughput. The advantages of using a generic specification are two-fold. On one hand, using a generic system specification allows the generation of multiple recommended system specifications (presumably at different price points), thus giving the customer greater flexibility to select a system having a throughput, which satisfies the customer's needs. On the other hand, the generic system specification is more suitable for being used as an input to a neural network that is trained based on training data, such as the training data set 124. As noted above, the training data is clustered, and in some respects, each performance identifier may be also be taught as a cluster that includes a corresponding part number. In other words, using a generic system specification as input to the neural network helps increase the resemblance which the input to the neural network 113 bears to the training data that is used to train the neural network.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid-state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. ./. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A method comprising:
obtaining an initial system specification for a system;
classifying the initial system specification by using a machine learning model that is configured to yield an estimated system throughput for the system;
detecting whether the estimated system throughput is greater than or equal to a required system throughput;
when the estimated system throughput is greater than or equal to the required system throughput, outputting one or more recommended system specifications that are based on the initial system specification.

2. The method of claim 1, further comprising, when the estimated system throughput is less than the required system throughput, discarding the initial system specification.

3. The method of claim 1, wherein the initial system specification includes a generic system specification containing a performance identifier, and outputting the one or more recommended system specifications includes:
generating a first recommended system specification by replacing the performance identifier with a first part identifier;
generating a second recommended system specification by replacing the performance identifier with a second part identifier; and
outputting the first recommend system specification and the second recommended system specification.

4. The method of claim 1, wherein the initial system specification includes a generic system specification containing a performance identifier, and outputting the one or more recommended system specifications includes: generating a recommended system specification by replacing the performance identifier with a corresponding part identifier, and outputting the generated recommended system specification.

5. The method of claim 1, wherein:
the initial system specification includes a generic system specification, and
obtaining the initial system specification includes: receiving a precise system specification and generating the generic system specification based on the precise system specification, the generic system specification being generated by replacing a part identifier that is provided in the precise system specification with a corresponding performance identifier.

6. The method of claim 1, wherein the machine learning model is trained based on a telemetry data set, the telemetry data set identifying a respective throughput of each of a plurality of deployed systems.

7. The method of claim 1, wherein the machine learning model includes a neural network that is trained based on a training data set, the method further comprising:
obtaining a telemetry data set, the telemetry data set identifying a respective throughput of each of a plurality of deployed systems;
obtaining a configuration data set, the configuration data set identifying a respective configuration of each of the plurality of deployed systems; and
generating the training data set based on the configuration data set and the telemetry data set.

8. An apparatus, comprising:
a memory; and
at least one processor operatively coupled to the memory, the at least one processor being configured to perform the operations of:
obtaining an initial system specification for a system;
classifying the initial system specification by using a machine learning model that is configured to yield an estimated system throughput for the system;
detecting whether the estimated system throughput is greater than or equal to a required system throughput; and
when the estimated system throughput is greater than or equal to the required system throughput, outputting one or more recommended system specifications that are based on the initial system specification.

9. The apparatus of claim 8, wherein the at least one processor is further configured to perform the operation of, when the estimated system throughput is less than the required system throughput, discarding the initial system specification.

10. The apparatus of claim 8, wherein the initial system specification includes a generic system specification containing a performance identifier, and outputting the one or more recommended system specifications includes:
generating a first recommended system specification by replacing the performance identifier with a first part identifier;
generating a second recommended system specification by replacing the performance identifier with a second part identifier; and
outputting the first recommend system specification and the second recommended system specification.

11. The apparatus of claim 8, wherein the initial system specification includes a generic system specification containing a performance identifier, and outputting the one or more recommended system specifications includes: generating a recommended system specification by replacing the performance identifier with a corresponding part identifier, and outputting the generated recommended system specification.

12. The apparatus of claim 8, wherein:
the initial system specification includes a generic system specification, and
obtaining the initial system specification includes: receiving a precise system specification and generating the generic system specification based on the precise system specification, the generic system specification being generated by replacing a part identifier that is provided in the precise system specification with a corresponding performance identifier.

13. The apparatus of claim 8, wherein the machine learning model is trained based on a telemetry data set, the telemetry data set identifying a respective throughput of each of a plurality of deployed systems.

14. The apparatus of claim 8, wherein the machine learning model includes a neural network that is trained based on a training data set, and the at least one processor is further configured to perform the operations of:
obtaining a telemetry data set, the telemetry data set identifying a respective throughput of each of a plurality of deployed systems;
obtaining a configuration data set, the configuration data set identifying a respective configuration of each of the plurality of deployed systems; and
generating the training data set based on the configuration data set and the telemetry data set.

15. A non-transitory computer-readable medium storing one or more processor-executable instructions, which, when executed by at least one processor, cause the at least one processor to perform to operations of:
a memory; and
at least one processor operatively coupled to the memory, the at least one processor being configured to perform the operations of:
obtaining an initial system specification for a system;
classifying the initial system specification by using a machine learning model that is configured to yield an estimated system throughput for the system;
detecting whether the estimated system throughput is greater than or equal to a required system throughput; and
when the estimated system throughput is greater than or equal to the required system throughput, outputting one or more recommended system specifications that are based on the initial system specification.

16. The non-transitory computer-readable medium of claim 15, wherein the one or more processor-executable instructions, when executed by the at least one processor, further cause the at least one processor to perform the operation of, when the estimated system throughput is less than the required system throughput, discarding the initial system specification.

17. The non-transitory computer-readable medium of claim 15, wherein the initial system specification includes a generic system specification containing a performance identifier, and outputting the one or more recommended system specifications includes:
generating a first recommended system specification by replacing the performance identifier with a first part identifier;
generating a second recommended system specification by replacing the performance identifier with a second part identifier; and
outputting the first recommend system specification and the second recommended system specification.

18. The non-transitory computer-readable medium of claim 15, wherein the initial system specification includes a generic system specification containing a performance identifier, and outputting the one or more recommended system specifications includes: generating a recommended system specification by replacing the performance identifier with a corresponding part identifier, and outputting the generated recommended system specification.

19. The non-transitory computer-readable medium of claim 15, wherein:
the initial system specification includes a generic system specification, and
obtaining the initial system specification includes: receiving a precise system specification and generating the generic system specification based on the precise system specification, the generic system specification being generated by replacing a part identifier that is provided in the precise system specification with a corresponding performance identifier.

20. The non-transitory computer-readable medium of claim 15, wherein the machine learning model is trained based on a telemetry data set, the telemetry data set identifying a respective throughput of each of a plurality of deployed systems.
